(19) United States
(12) Patent Application Publication
(10) Pub. No.: US 2010/0130259 A1
(43) Pub. Date: May 27, 2010

(54) MOBILE TERMINAL WITH IMAGE PROJECTOR AND METHOD OF STABILIZING IMAGE THEREIN

(75) Inventor: Dong Hoon LEE, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/616,757

(22) Filed: Nov. 11, 2009

(30) Foreign Application Priority Data
Nov. 27, 2008 (KR) 10-2008-0119016

(51) Int. Cl. G03B 5/00; H04W 88/02

(52) U.S. Cl. 455/566; 353/69; 353/30; 353/121

(57) ABSTRACT

A mobile terminal and image stabilizing method therein are disclosed. When a prescribed image is projected using a projector module provided to a mobile terminal, hand shaking is detected by a sensing unit and is then corrected. Therefore, shaking of a projected image can be corrected.

This application claims the benefit of the Korean Patent Application No. 10-2008-0119016, filed on Nov. 27, 2008, which is hereby incorporated by reference as if fully set forth herein.

### BACKGROUND OF THE INVENTION

1. Field of the Invention

The present invention relates to a mobile terminal and controlling method thereof, and more particularly, to a mobile terminal having an image projector and controlling method thereof.

2. Discussion of the Related Art

Generally, terminals can be classified into mobile/portable terminals and stationary terminals according to availability for mobility. The mobile terminals can be classified into handheld terminals and vehicle mount terminals again according to possibility of user's direct portability.

As functions of the mobile terminal are diversified, the mobile terminal is implemented as a multimedia player provided with composite functions such as photographing of photos or moving pictures, playback of music or moving picture files, game play, broadcast reception and the like for example.

To support and enhance functions of the mobile terminals, it may be able to consider the improvement of structural part and/or software part of the mobile terminal. In particular, an image projector is provided to the mobile terminal to provide a larger display means. When a user is using a mobile terminal having an image projector by getting a handhold on the mobile terminal, hand shaking causes an image to be unstably projected on a screen. Therefore, the demand for a solution for image stabilization has risen.

However, a system for inclining a lens in a direction for canceling out hand shaking using a mechanical device provided to a lens barrel or a conventional hand-shaking correcting system for moving an image pickup device, e.g., CMOS or CCD module by being applied to an optical device is not suitable for a mobile terminal due to the weight and volume of the correcting device.

### SUMMARY OF THE INVENTION

Accordingly, the present invention is directed to a mobile terminal having an image projector and controlling method thereof that substantially obviate one or more problems due to limitations and disadvantages of the related art.

An object of the present invention is to provide a mobile terminal, by which hand shaking can be corrected without using a separate mechanical device for moving a projector module.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mobile terminal according to the present invention includes a projector module projecting a first display within a projection area corresponding to a maximum projectable size on an external plane, a sensing unit detecting shaking of the projector module, and a controller controlling the first display to be displayed on a fixed position of the external plane by moving the first display within the projection area to cancel out the shaking.

In another aspect of the present invention, a method of correcting hand shaking in a mobile terminal includes the steps of generating displacement information by having a sensing unit detect shaking, calculating a correction value using the displacement information, determining whether the calculated correction value lies within a correctible range, and if the calculated correction value lies within the correctible range, correcting a first display according to the correction value within a projection area and projecting the corrected first display on a prescribed external plane via a projector module.

Accordingly, the present invention corrects hand shaking, thereby preventing an image from being unstably projected on a screen.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to one embodiment of the present invention;

FIG. 2A is a front perspective diagram of a mobile terminal according to one embodiment of the present invention;

FIG. 2B is a rear perspective diagram of a mobile terminal according to one embodiment of the present invention;

FIG. 3A and FIG. 3B are front diagrams of a mobile terminal according to one embodiment of the present invention for explaining one operational status of the mobile terminal, respectively;

FIG. 4 is a diagram to explain the concept of proximity depth of a proximity sensor;

FIG. 5 is a diagram to explain the concept of a method of controlling a touch action on a pair of display units overlapped with each other;

FIG. 6A and FIG. 6B are diagrams to explain the concepts of a proximity touch recognizing area for detecting a proximity signal and a haptic area for generating a tactile effect, respectively;

FIG. 7A and FIG. 7B are perspective diagrams of a mobile terminal according to one embodiment of the present invention;

FIG. 8 is a diagram to explain a direction of motion of a mobile terminal according to one embodiment of the present invention, in which the mobile terminal is moved by hand shaking;

FIG. 9 is a conceptional diagram of an image projected by a mobile terminal according to one embodiment of the present invention;

FIG. 10 is a diagram to explain a concept of a method of correcting shaking of a mobile terminal according to a first embodiment of the present invention on Y-axis;

FIG. 11 is a diagram to explain a concept of a method of correcting shaking of a mobile terminal according to a first embodiment of the present invention on X-axis;

FIG. 12 is a flowchart for a method of correcting hand shaking of a mobile terminal according to a first embodiment of the present invention;

FIG. 13 is a diagram of a correction table used for method of correcting hand shaking of a mobile terminal according to a first embodiment of the present invention;

FIG. 14 is a diagram to explain a concept of a method of correcting shaking of a mobile terminal according to a second embodiment of the present invention on Z-axis;

FIG. 15 is a diagram to explain a concept of a method of correcting a rotation centering on a z-axis in a mobile terminal according to a third embodiment of the present invention; and

FIG. 16 is a diagram of the concept of utilization of a second display in a mobile terminal according to a fourth embodiment of the present invention on Z-axis.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile as well as stationary terminals, such as mobile phones, user equipment, smart phones, DTV, computers, digital broadcast terminals, personal digital assistants, portable multimedia players (PMP) and navigators.

However, by way of non-limiting example only, further description will be with regard to a mobile terminal 100, and it should be noted that such teachings may apply equally to other types of terminals.

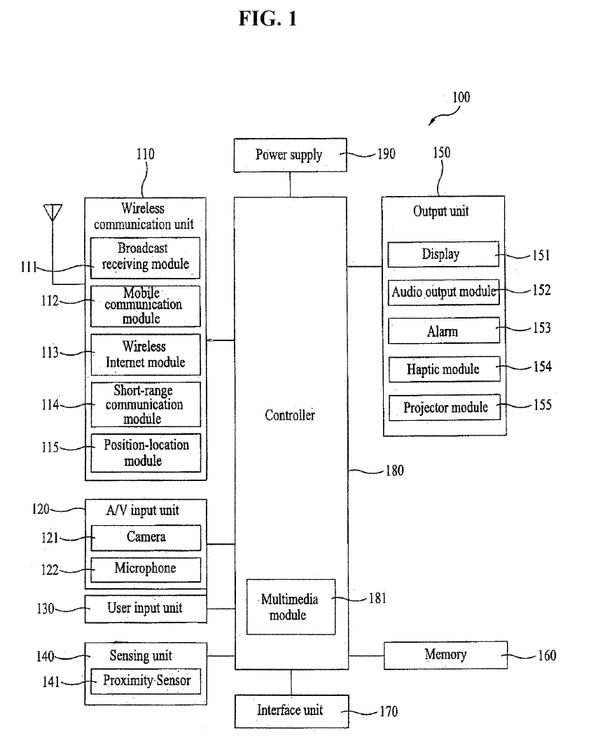

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.). Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), etc.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100.

As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, a haptic module 154, a projector module 155 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor (not shown in the drawing) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

In the following description, for clarity, an action that a pointer approaches without contacting with the touchscreen to be recognized as located on the touchscreen is named ‘proximity touch’. And, an action that a pointer actually touches the touchscreen is named ‘contact touch’. The meaning of the position on the touchscreen proximity-touched by the pointer means the position of the pointer which vertically opposes the touchscreen when the pointer performs the proximity touch.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. And, the projector module 155 is able to display an image, which is identical to or partially different at least from the image displayed on the display 151, on an external screen or wall according to a control signal of the controller 180.

In particular, the projector module 155 can include a light source (not shown in the drawing) generating light (e.g., laser) for projecting an image externally, an image producing means (not shown in the drawing) for producing an image to output externally using the light generated from the light source, and a lens (not shown in the drawing) for enlarging to output the image externally in a predetermined focus distance. And, the projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. And, it is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures, moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

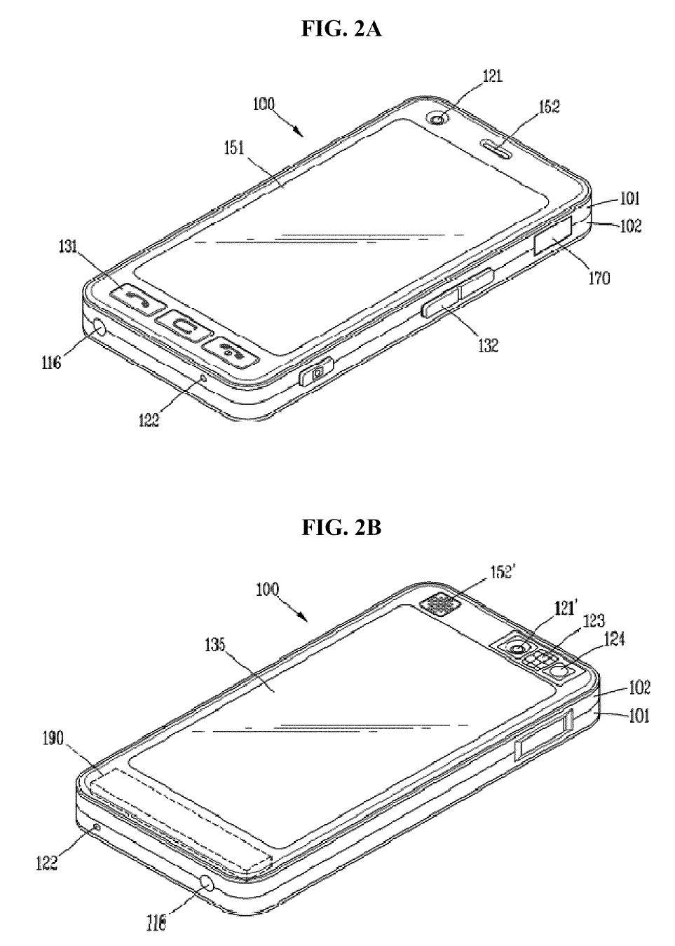

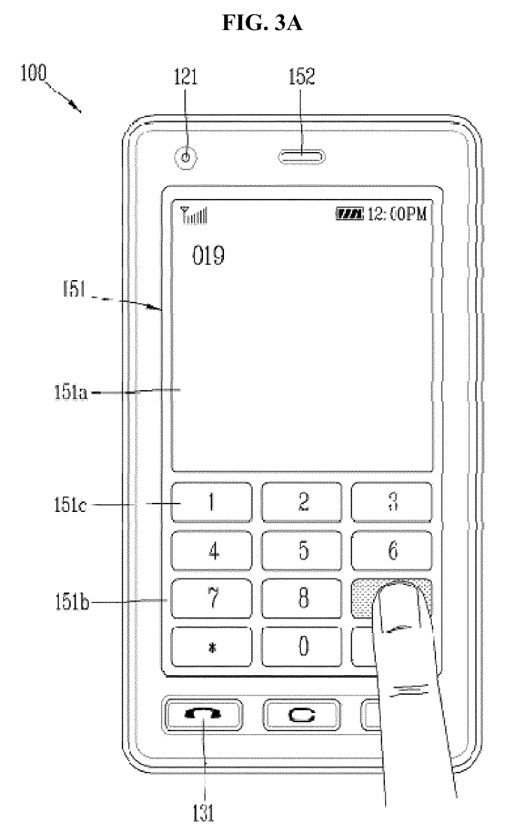

FIG. 2A is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2A, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

FIG. 2B is a perspective diagram of a backside of the terminal shown in FIG. 2A.

Referring to FIG. 2B, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2A and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display 151. In this case, if the display 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

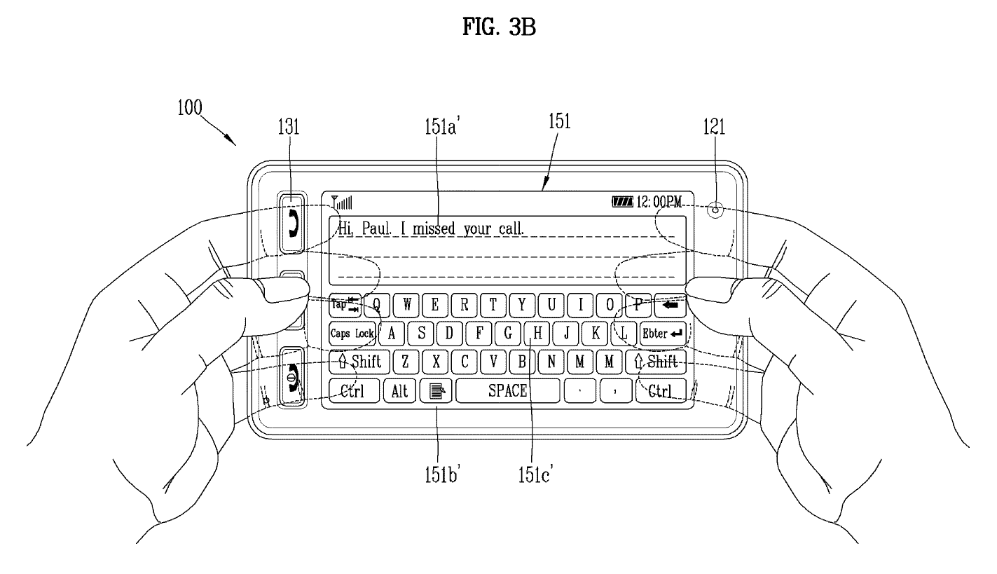

Interconnected operational mechanism between the display 151 and the touchpad 135 are explained with reference to FIG. 3A and FIG. 3B as follows.

FIG. 3A and FIG. 3B are front-view diagrams of a terminal according to one embodiment of the present invention for explaining an operational state thereof.

First of all, various kinds of visual informations can be displayed on the display 151. And, theses informations can be displayed in characters, numerals, symbols, graphics, icons and the like.

In order to input the information, at least one of the characters, numerals, symbols, graphics and icons are represented as a single predetermined array to be implemented in a keypad formation. And, this keypad formation can be so-called ‘soft keys’.

FIG. 3A shows that a touch applied to a soft key is inputted through a front face of a terminal body.

The display 151 is operable through an entire area or by being divided into a plurality of regions. In the latter case, a plurality of the regions can be configured interoperable.

For instance, an output window 151a and an input window 151b are displayed on the display 151. A soft key 151c′ representing a digit for inputting a phone number or the like is outputted to the input window 151b. If the soft key 151c′ is touched, a digit corresponding to the touched soft key is outputted to the output window 151a. If the first manipulating unit 131 is manipulated, a call connection for the phone number displayed on the output window 151a is attempted.

FIG. 3B shows that a touch applied to a soft key is inputted through a rear face of a terminal body. If FIG. 3A shows a case that the terminal body is vertically arranged (portrait), FIG. 3B shows a case that the terminal body is horizontally arranged (landscape). And, the display 151 can be configured to change an output picture according to the arranged direction of the terminal body.

FIG. 3B shows that a text input mode is activated in the terminal.

An output window 151a′ and an input window 151b′ are displayed on the display 151. A plurality of soft keys 151c′ representing at least one of characters, symbols and digits can be arranged in the input window 151b′. The soft keys 151c′ can be arranged in the QWERTY key formation.

If the soft keys 151c′ are touched through the touchpad (cf. ‘135’ in FIG. 2B), the characters, symbols and digits corresponding to the touched soft keys are outputted to the output window 151a′. Thus, the touch input via the touchpad 135 is advantageous in that the soft keys 151c′ can be prevented from being blocked by a finger in case of touch, which is compared to the touch input via the display 151. In case that the display 151 and the touchpad 135 are configured transparent, it is able to visually check fingers located at the backside of the terminal body. Hence, more correct touch inputs are possible.

Besides, the display 151 or the touchpad 135 can be configured to receive a touch input by scroll. A user scrolls the display 151 or the touchpad 135 to shift a cursor or pointer located at an entity (e.g., icon or the like) displayed on the display 151. Furthermore, in case that a finger is shifted on the display 151 or the touchpad 135, a path of the shifted finger can be visually displayed on the display 151. This may be useful in editing an image displayed on the display 151.

To cope with a case that both of the display (touchscreen) 151 and the touchpad 135 are touched together within a predetermined time range, one function of the terminal can be executed. The above case of the simultaneous touch may correspond to a case that the terminal body is held by a user using a thumb and a first finger (clamping). The above function can include activation or deactivation for the display 151 or the touchpad 135.

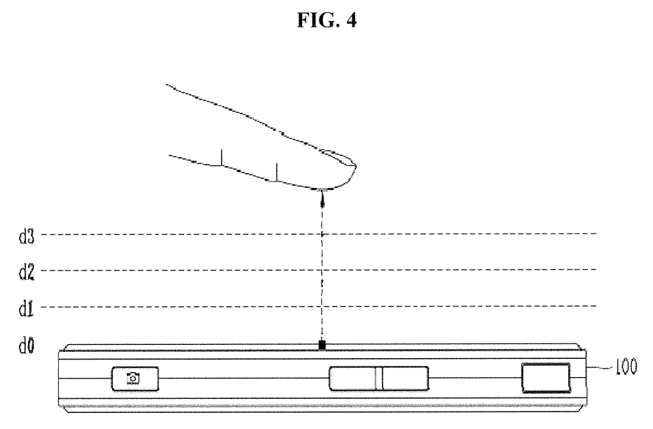

The proximity sensor 141 described with reference to FIG. 1 is explained in detail with reference to FIG. 4 as follows.

FIG. 4 is a conceptional diagram for explaining a proximity depth of a proximity sensor.

Referring to FIG. 4, when such a pointer as a user's finger, a pen and the like approaches the touchscreen, a proximity sensor 141 provided within or in the vicinity of the touchscreen detects the approach of the pointer and then outputs a proximity signal.

The proximity sensor 141 can be configured to output a different proximity signal according to a distance between the pointer and the proximity-touched touchscreen (hereinafter named ‘proximity depth).

In FIG. 4, exemplarily shown is a cross-section of the touchscreen provided with a proximity sensor capable to three proximity depths for example. And, it is understood that a proximity sensor capable of proximity depths amounting to the number smaller than 3 or equal to or greater than 4 is possible.

In detail, in case that the pointer is fully contacted with the touchscreen (d0), it is recognized as a contact touch. In case that the pointer is located to be spaced apart from the touchscreen in a distance smaller than d1, it is recognized as a proximity touch to a first proximity depth. In case that the pointer is located to be spaced apart from the touchscreen in a distance between d1 and d2, it is recognized as a proximity touch to a second proximity depth. In case that the pointer is located to be spaced apart from the touchscreen in a distance smaller than d3 or equal to or greater than d2, it is recognized as a proximity touch to a third proximity depth. In case that the pointer is located to be spaced apart from the touchscreen in a distance equal to or greater than d3, it is recognized as a proximity touch is released.

Hence, the controller 180 is able to recognize the proximity touch as one of various input signals according to the proximity depth and position of the pointer. And, the controller 180 is able to perform various operation controls according to the various input signals.

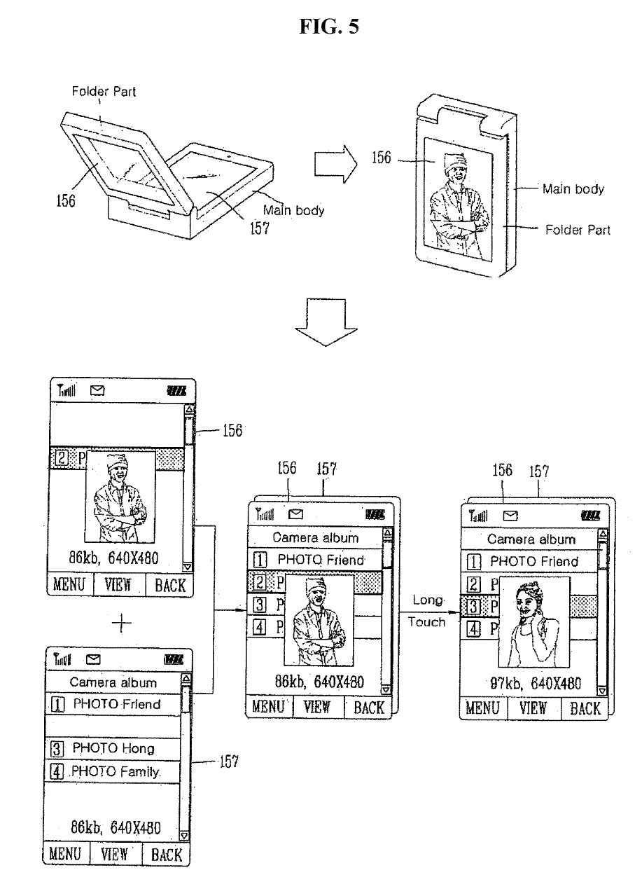

FIG. 5 is a conceptional diagram for exampling a method of controlling a touch action in a state that a pair of displays 156 and 157 are overlapped with each other.

Referring to FIG. 5, a terminal shown in the drawing is a folder type terminal in which a folder part is connected to a main body in a manner of being folded or unfolded.

A first display 156 provided to the folder part is a light-transmittive or transparent type such as TOLED, while a second display 157 provided to the main body may be a non-transmittive type such as LCD. Each of the first and second displays 156 and 157 can include a touch-inputable touchscreen.

For instance, if a touch (contact touch or proximity touch) to the first display or TOLED 156 is detected, the controller 180 selects or runs at least one image from an image list displayed on the TOLED 156 according to a touch type and a touch duration.

In the following description, a method of controlling information displayed on a different display or an LCD 157 in case of an touch to the TOLED 156 externally exposed in an overlapped configuration is explained, in which the description is made with reference to input types classified into a touch, a long touch, a long-touch & drag and the like.

In the overlapped state (a state that mobile terminal is closed or folder), the TOLED 156 is configured to be overlapped with the LCD 157. In this state, if a touch different from a touch for controlling an image displayed on the TOLED 155, e.g., a long touch (e.g., a touch having a duration of at least 2 seconds) is detected, the controller 180 enables at least one image to be selected from an image list displayed on the LCD 157 according to the touched touch input. The result from running the selected image is displayed on the TOLED 156.

The long touch is usable in selectively shifting a specific one of entities displayed on the LCD 157 to the TOLED 156 (without an action for running the corresponding entity). In particular, if a user performs a long touch on a prescribed region of the TOLED 156 corresponding to a specific entity of the LCD 157, the controller 180 controls the corresponding entity to be displayed by being shifted to the TOLED 156.

Meanwhile, an entity displayed on the TOLED 156 can be displayed by being shifted to the LCD 157 according to such a prescribed touch input to the TOLED 156 as flicking, swirling and the like. In the drawing, exemplarily shown is that a second menu displayed on the LCD 157 is displayed by being shifted to the TOLED 156.

In case that another input, e.g., a drag is additionally detected together with a long touch, the controller 180 executes a function associated with an image selected by the long touch so that a preview picture for the image can be displayed on the TOLED 156 for example. In the drawing, exemplarily shown is that a preview (picture of a male) for a second menu (image file) is performed.

While the preview image is outputted, if a drag toward a different image is additionally performed on the TOLED 156 by maintaining the long touch, the controller 180 shifts a selection cursor (or a selection bar) of the LCD 157 and then displays the image selected by the selection cursor on the preview picture (picture of female). Thereafter, after completion of the touch (long touch and drag), the controller 180 displays the initial image selected by the long touch.

The touch action (long touch and drag) is identically applied to a case that a slide (action of a proximity touch corresponding to the drag) is detected to together with a long proximity touch (e.g., a proximity touch maintained for at least 2 or 3 seconds) to the TOLED 156.

In case that a touch action differing from the above-mentioned touch actions is detected, the controller 180 is able to operate in the same manner of the general touch controlling method.

The method of controlling the touch action in the overlapped state is applicable to a terminal having a single display. And, the method of controlling the touch action in the overlapped state is applicable to terminals differing from the folder type terminal having a dual display as well.

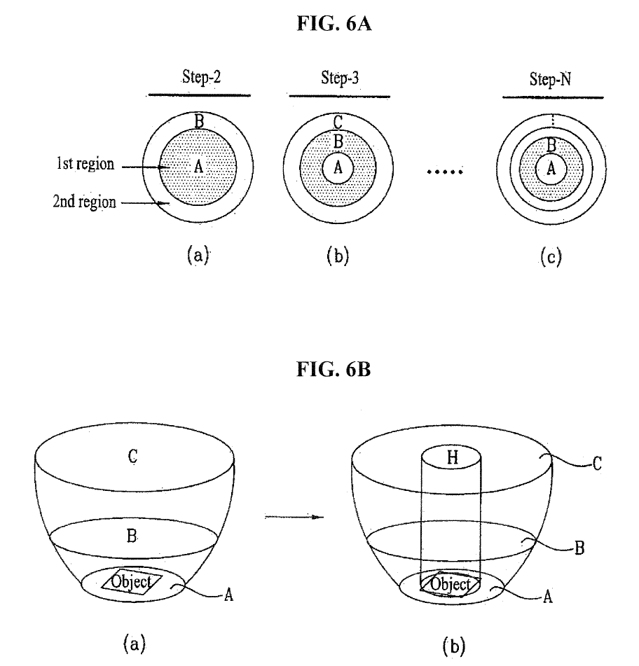

FIG. 6A and FIG. 6B are diagrams for the description of a proximity touch recognition area and a tactile effect generation region.

FIG. 6A represents such an object as an icon, a menu item and the like in a circle type for clarity and convenience of explanation.

A region for displaying an object on the display 151, as shown in (a) of FIG. 6A, can be divided into a first region A at a central part and a second region B enclosing the first region A. The first and second regions A and B can be configured to generate tactile effects differing from each other in strength or pattern. For instance, the first and second regions can be configured to generate 2-step vibrations in a manner of outputting a first vibration if the second region B is touched or outputting a second vibration greater than the first vibration if the first region A is touched.

In case that both of the proximity touch recognition region and the haptic region are simultaneously set in the region having the object displayed therein, it is able to set the haptic region for generating the tactile effect to be different from the proximity touch recognition region for detecting the proximity signal. In particular, it is able to set the haptic region to be narrower or wider than the proximity touch recognition region. For instance, in (a) of FIG. 6A, it is able to set the proximity touch recognition region to the area including both of the first and second regions A and B. And, it is able to set the haptic region to the first region A.

It is able to discriminate the region having the object displayed therein into three regions A, B and C as shown in (b) of FIG. 6A. Alternatively, it is able to discriminate the region having the object displayed therein into N regions (N>4) as shown in (c) of FIG. 6A. And, it is able to configure each of the divided regions to generate a tactile effect having a different strength or pattern. In case that a region having a single object represented therein is divided into at least three regions, it is able to set the haptic region and the proximity touch recognition region to differ from each other according to a use environment.

It is able to configure a size of the proximity touch recognition region of the display 151 to vary according to a proximity depth. In particular, referring to (a) of FIG. 6B, the proximity touch recognition region is configured to decrease by C→B→A according to the proximity depth for the display 151. On the contrary, the proximity touch recognition region is configured to increase by C→B→A according to the proximity depth for the display 151. Despite the above configuration, it is able to set the haptic region to have a predetermined size, as the region ‘H’ shown in (b) of FIG. 6B, regardless of the proximity depth for the display 151.

In case of dividing the object-displayed region for the setting of the haptic region or the proximity touch recognition region, it is able to use one of various schemes of horizontal/vertical division, radial division and combinations thereof as well as the concentric circle type division shown in FIG. 6A.

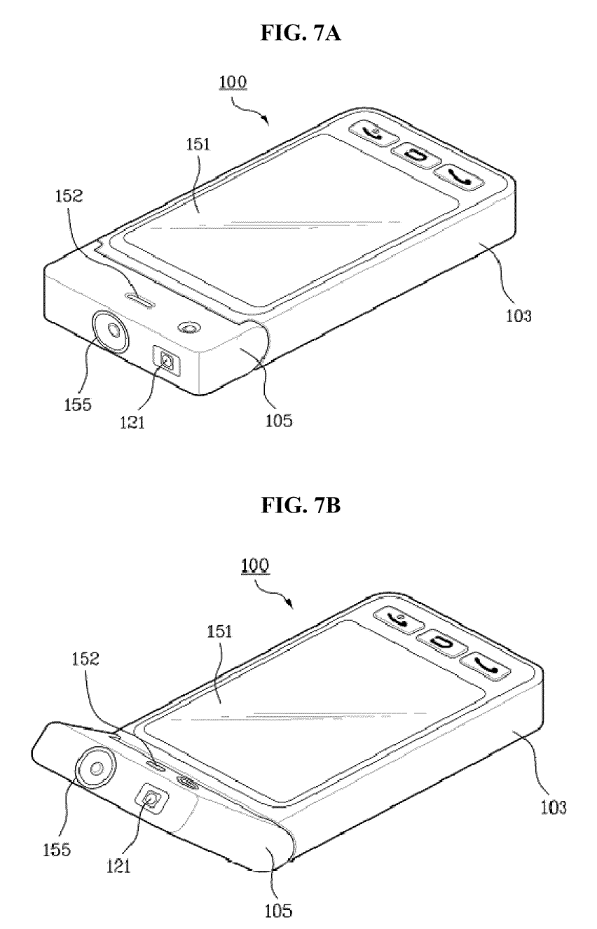

In the following description, the configuration of the above-described projector module provided to the bar type mobile terminal 100 is explained in detail with reference to FIG. 7A and FIG. 7B.

FIG. 7A and FIG. 7B are perspective diagrams of a mobile terminal according to one embodiment of the present invention.

Referring to FIG. 7A, a projector body 105 having a projector module 155 can be rotatably coupled to a main body 103 of the mobile terminal.

In particular, the projector body 105 can be hinged to the main body 103. A projected angle of an image, which is projected using the projector module 155 provided to the projector body 105, can be controlled. And, a camera 121 can be provided to the projector body 105 to photograph the image projected by the projector module 155.

FIG. 7A shows a status before the projector body 105 rotatably coupled to the main body 103 is rotated, and FIG. 7B shows a status after the projector body 105 has been rotated.

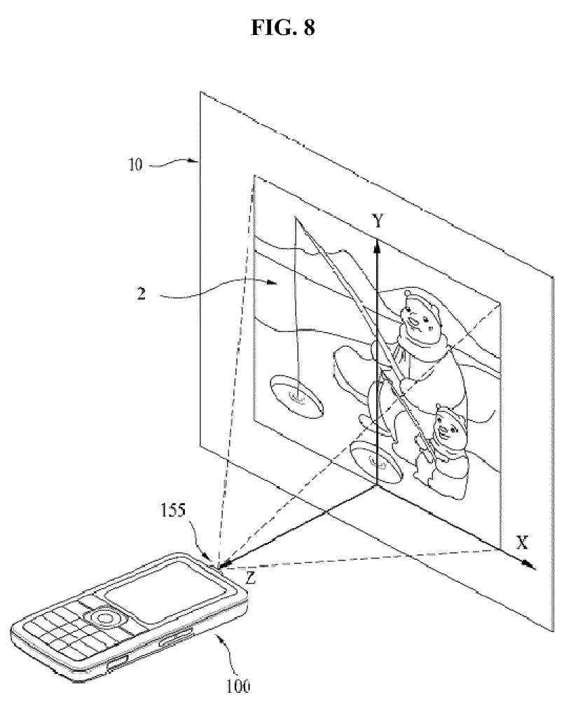

If a user gets a handhold on the projector module and enabling a prescribed image to be projected from the projector module, the image projected on the screen is shaken together with shaking of user's hand. A direction and extent of this shaking are defined with reference to FIG. 8 as follows.

FIG. 8 is a diagram to explain a direction of motion of a mobile terminal according to one embodiment of the present invention, in which the mobile terminal is moved by hand shaking.

Referring to FIG. 8, the mobile terminal having the projector module 155 is projecting a prescribed image 2 on a screen 10. In this case, it is able to represent a direction and extent of possible hand shaking using a 3-dimensional coordinate system including axes X, Y and Z. In this disclosure, for clarity of explanation, as shown in FIG. 8, when the screen 10 is viewed from the projector module 155, a right side is defined as a direction +X, a left side is defined as a direction −X, a direction toward sky is defined as a direction +Y, and a direction toward ground is defined as a direction −Y. A direction facing the projector module 155 from the screen 10 is defined as a direction −Z. And, a direction opposite to the direction −Z is defined as a direction +Z.

First of all, a mobile terminal, which is capable of preventing an image projected on a screen from being shaken in a manner of correcting hand shaking on axes X and Y, according to a first embodiment of the present invention is explained as follows.

### First Embodiment

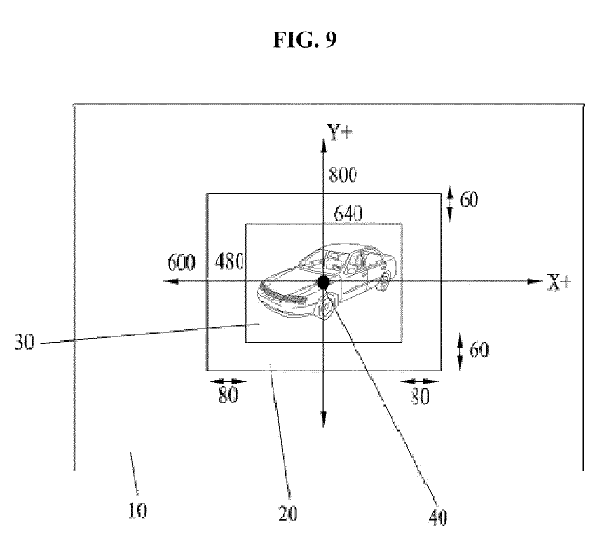

A terminal according to a first embodiment of the present invention is explained with reference to FIGS. 9 to 13. According to a first embodiment of the present invention, provided is a method of correcting hand shaking in a manner of detecting mobile terminal shaking generated from hand shaking and then shifting an image, which results from reducing an image to be projected by a prescribed ratio, in parallel within a maximum projectable area.

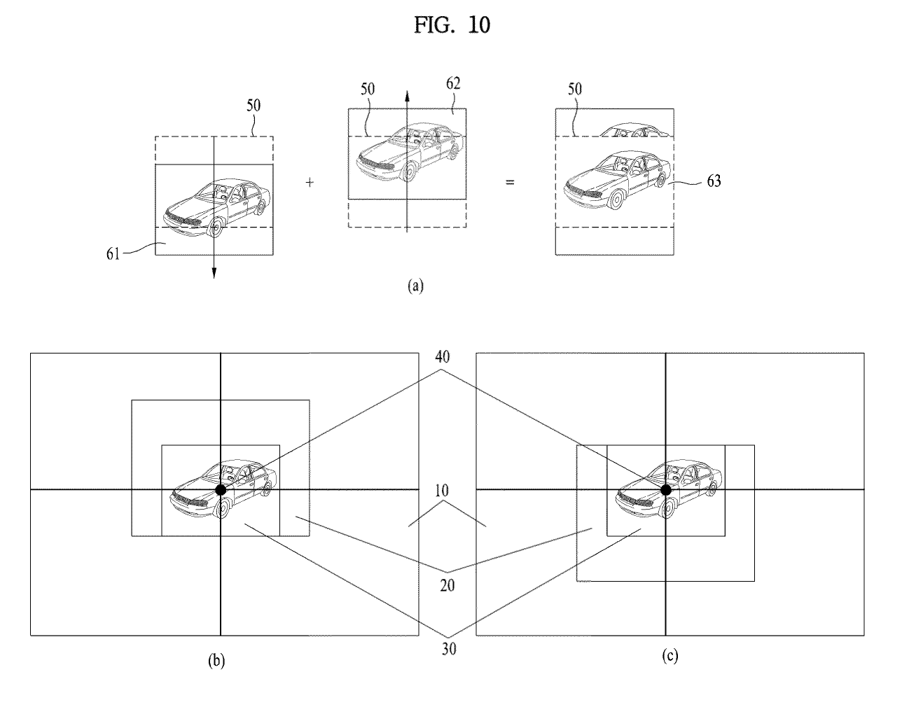

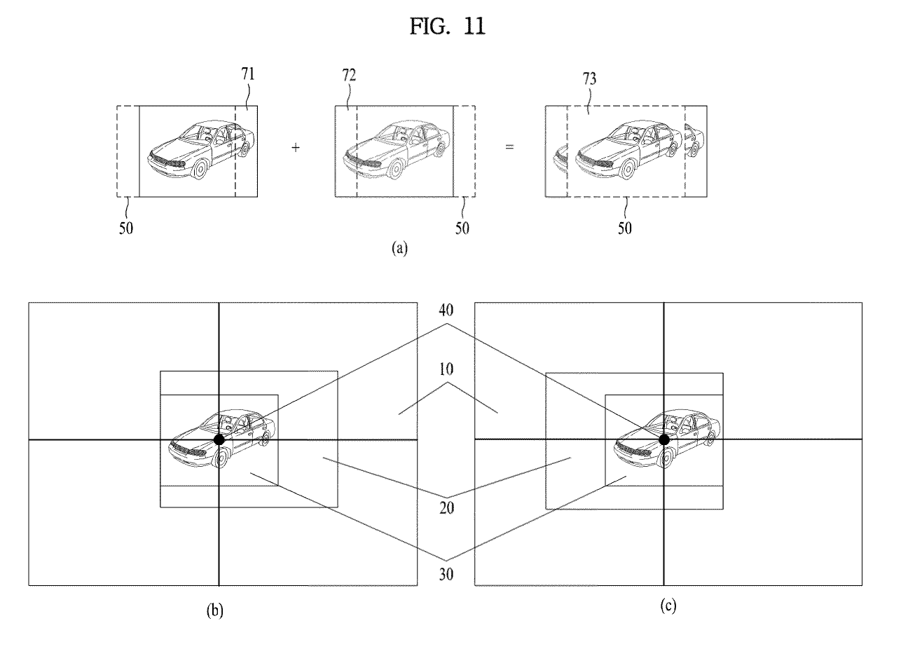

Basic concepts used for a hand shaking correcting method according the present embodiment are explained with reference to FIGS. 9 to 11. FIG. 9 shows an example that a hand shaking correctible image is projected on a prescribed external plane by a mobile terminal according to the present invention. FIG. 10 is a diagram to explain a method of correcting shaking in Y-axis direction. And, FIG. 11 is a diagram to explain a method of correcting shaking in X-axis direction.

Referring to FIG. 9, the mobile terminal 100 is projecting a prescribed image 30 on a prescribed external plane 10 within a maximum projectable area 20 using the projector module 155. In this case, the prescribed external plane 10 means a plane on which an image is projected. Preferably, the prescribed external plane 10 includes such an even plane as an image projector dedicated screen and is white.

Moreover, the external plane of the present invention is non-limited to the above even plane. The external plane can include every plane (e.g., paper, wall of building, ceiling, etc.) on which an image outputted from the projector module 155 can be projected. In this disclosure, assume that the prescribed external plane 10 includes ‘screen’.

The maximum projectable area 20 is related to unique performance of the projector module. When the projector module projects an image with maximum resolution, the maximum projectable area 20 indicates a total size occupied by the image projected on a prescribed external plane.

And, the prescribed image 30 includes an image resulting from reducing a specific image, which is attempted by a user to be projected on an external plane through the projector module 155, by a prescribed ratio of maximum resolution of the projector module 155. Therefore, the prescribed image 30 is the image the user wishes to view without shaking on the screen 10.

In the following description of this disclosure, the maximum projectable area 20 is named ‘projection area’, the image 30 reduced by the prescribed ratio is named ‘first display’, and an image projected on an area except the first display within the ‘projection area’ is named ‘second display’. Hence, if one area having the first display displayed thereon and the other area having the second display displayed thereon are added together, they result in the ‘projection area’.

The basic concepts of the present invention are further explained based on the above-defined terminologies as follows.

If the projector module 155 is fixed to the mobile terminal 100 (i.e., there is no separate mechanical operation for correction), the projection area 20 cannot help moving on the screen 10 toward a motional direction of the mobile terminal 100. Yet, the first display 30 is free to move according to a signal for the controller 180 to the projector module 155 as long as the first display 30 stays within a range of the projection area 20.

Accordingly, if the first display 30 is moved within the projection area 20 in a direction opposite to hand shaking to cancel out, the hand shaking can be corrected. Therefore, the first display 30 can be stably displayed on a fixed position of the screen 30.

For instance, as shown in FIG. 9, assume that a prescribed image is projected by the mobile terminal 100 provided with the projector module 155 of maximum resolution 800×600. The projection area 20 has a size of 800×600, and the first display 30 is set to a size of 640×480 reduced 20% smaller than the size of the projection area 20. Therefore, a range for allowing the first display 30 to move on the projection area 20 corresponds to resolution of ±80 in X-axis direction and resolution of ±60 in Y-axis direction with reference to a center 40.

If the mobile terminal 100 is moved by hand shaking to the extent corresponding to resolution of 20 in direction +X, the projection area 20 is moved by the same displacement. In this case, the first display 30 is moved in parallel to the extent corresponding to resolution of 20 in direction −X in order to cancel out the displacement of the projection area 20. If so, in view point of the screen 10, a center of the first display keeps staying at the same point 40 of the position before the mobile terminal 100 is moved. Therefore, the hand shaking is corrected.

In correcting the hand shaking by the above-mentioned method, a maximum correctible displacement of the mobile terminal 100 is determined according to a ratio of the first display reduced to the projection area. For instance, in case of the 20% reduction shown in FIG. 9, it is able to correct the shaking that corresponds to the resolution of ±80 in X-axis direction. In case of the 50% reduction, since the first display has a size of 400×300, it is able to correct the shaking corresponding to the resolution of ±200 in X-axis direction and the resolution of ±150 in Y-axis direction. Therefore, the reduction ratio of the first display can be appropriately determined to meet the user's necessity.

An example for correcting shaking in axes X and Y according to the above-explained embodiment is further explained with reference to FIG. 10 and FIG. 11 as follow. Correction for shaking in Y-axis direction is explained with reference to FIG. 10.

Referring to (a) of FIG. 10, as the mobile terminal 100 is moved up and down by user's hand shaking, an image attempted to be projected by a user is moving between a lower position 61 and a higher position 62 centering on an initial projection position 50. Consequently, the user views a shaking image 63. Referring to (b) of FIG. 10, as the mobile terminal 100 is shaken in direction +Y, a projection area 20 is shifted away from the reference point 40 of a screen in direction +Y.

If the first display 30 is shifted in parallel in direction −Y by applying the hand shaking correcting method according to the present embodiment as far as the projection area 20 has been shifted, the first display 30 stays at a center of the reference point 40. Therefore, the image the user attempts to project is not shaken. On the contrary, referring to (b) of FIG. 10, if the mobile terminal 100 is shaken on the axis −Y, the shaking can be corrected in a manner of shifting the first display 30 in parallel in direction +Y as far as the projection area 20 has been shifted in the direction −Y.

Correction for shaking in X-axis direction is explained as follows.

Referring to (a) of FIG. 11, as the mobile terminal 100 is moved right and left by user's hand shaking in a manner similar to that of the shaking in the Y-axis direction, an image attempted to be projected by a user is moving between a right side 71 and a left side 72 centering on an initial projection position 50. Consequently, the user views a shaking image 73. Referring to (b) and (c) of FIG. 11, by applying the hand shaking correcting method according to the present embodiment, correction can be performed in the same manner of the former correction for the shaking in the Y-axis direction.

If both of the shaking in the Y-axis direction and the shaking in the X-axis direction simultaneously take place, both of the former hand shaking correcting method for the Y-axis direction and the latter hand shaking correcting method for the X-axis direction are simultaneously applied to correct the hand shaking.

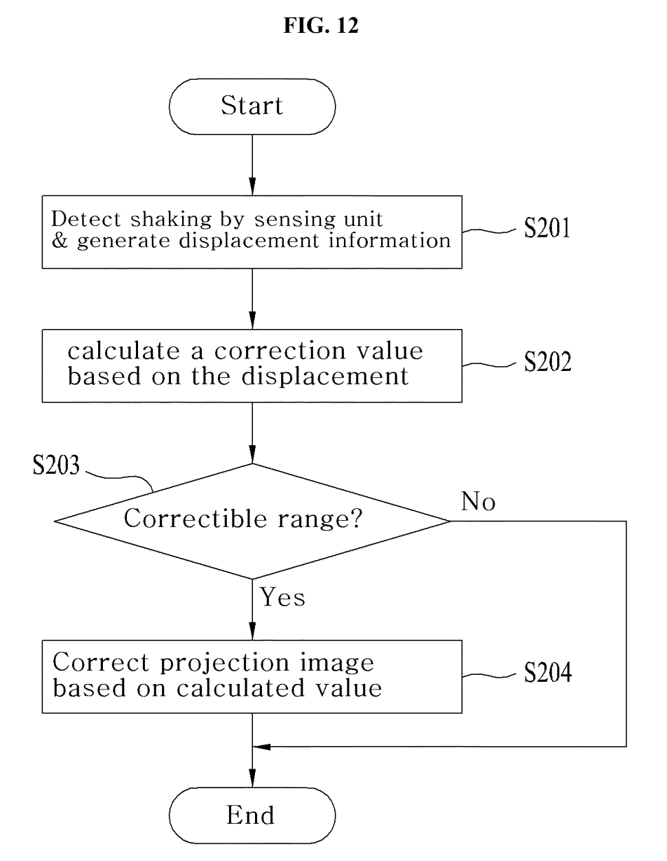

Based on the above-described basic concepts of the present invention, a hand shaking correcting process according to the first embodiment of the present invention is explained with reference to the flowchart shown in FIG. 12 as follows.

Referring to FIG. 12, the sensing unit 140 provided to the mobile terminal 100 generates displacement information by detecting a direction and extent of shaking of the mobile terminal 100 due to user's hand shaking [S201]. In this case, the sensing unit 140 preferably includes an acceleration sensor, a gyro-sensor or the like. Moreover, every sensor capable of generating the displacement information is applicable to the sensing unit 140. Besides, the displacement information may include a displacement of the shaking detected by the sensing unit 140, and more particularly, information on a direction and distance of shaking.

Subsequently, the controller 180 receives an input of the displacement information from the sensing unit 140 and then calculates a correction value based on the displacement information [S202]. In this case, the correction value indicates a direction and distance for shifting the first display 30 to cancel out the detected hand shaking.

As mentioned in the foregoing description, a correctible maximum displacement is determined according to a ratio of reducing the first display 30 against the projection area 20. A maximum correctible displacement determined according to the preset reduction ratio is compared to the correction value [S203].

As a result of the comparison, if the correction value is smaller than the maximum correctible displacement according to the reduction ratio, the first display 30 is moved in parallel according to the correction value [S204]. Otherwise, it is determined that a point to project the first display 30 thereon is moved on the screen 10. Hence, correction may not be performed. Of course, if the correction value exceeds the maximum correctible range, it is able to perform correction corresponding to the maximum correctible displacement.

Meanwhile, the step S202 of calculating the correction value based on the displacement information inputted from the sensing unit 140 can be performed by referring to a prescribed preset look-up table. Moreover, if a range of displacement to correct is preset in the look-up table and correction is set not to be performed on a displacement out of the range, the step S203 of comparing the maximum correctible displacement to the correction value can be further performed by referring to the look-up table. In this case, the look-up table is preferably prepared separate according to a ratio of the first display 30 reduced against a size of the projection area 20. As mentioned in the foregoing description, this is because a correctible maximum range varies according to the reduction ratio.

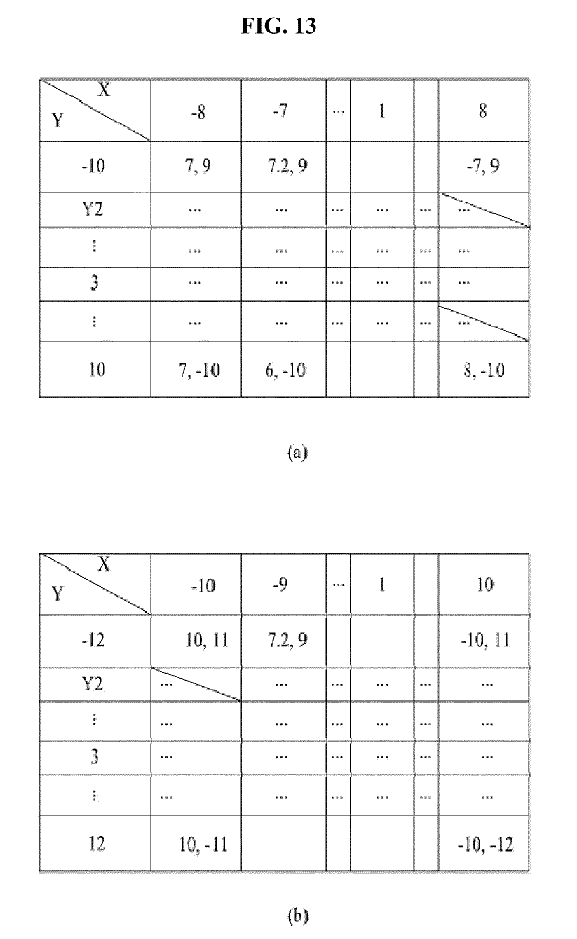

The above description is explained with reference to FIG. 13 as follows. When the reduction ratio is 20%, an example of a look-up table for correcting shaking on axes X and Y is shown in (a) of FIG. 13. When the reduction ratio is 30%, an example of a look-up table for correcting shaking on axes X and Y is shown in (b) of FIG. 13. As the reduction ratio increases, so does a range of a correctible displacement. Therefore, it can be observed that the look-up table according to the reduction ratio 30% has a correction range wider than that of the look-up table according to the reduction ratio 20%.

Thus, a faster correction speed is obtained from quick calculation of the correction value. And, it is able to lessen the operation load put on the controller 180.

In the above description, the method of correcting the shaking of the mobile terminal in the X- and Y-axis directions is explained. In the following description, a hand shaking correcting method for correcting shaking in Z-axis direction according to a second embodiment of the present invention is explained.

### Second Embodiment

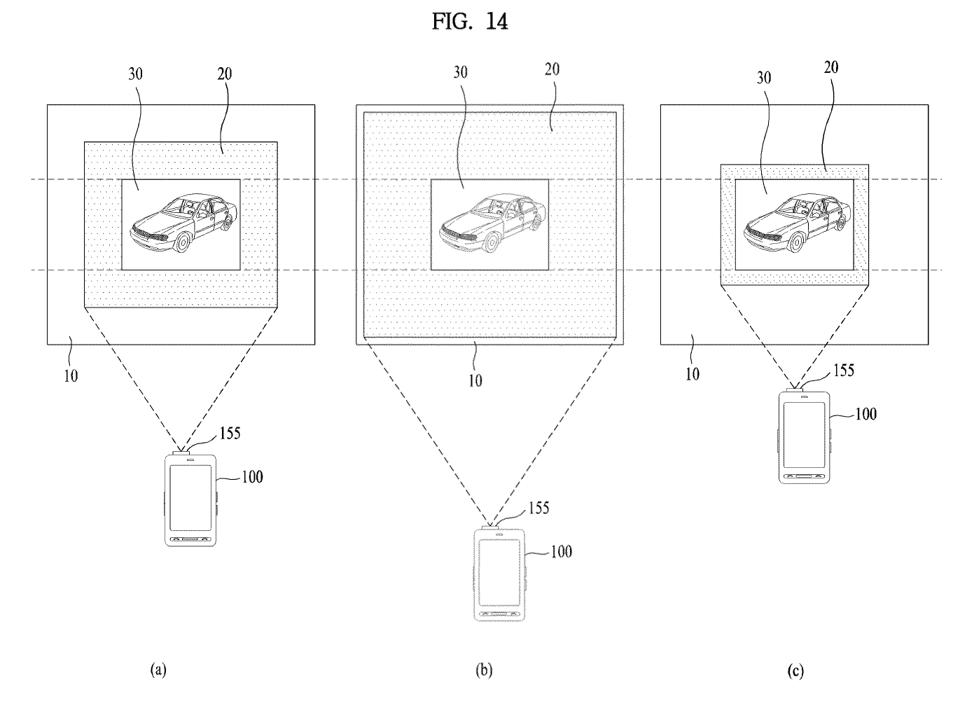

A mobile terminal according to a second embodiment of the present invention is explained with reference to FIG. 14. The present embodiment provides a method of correcting hand shaking on axis Z by detecting mobile terminal shaking generated from hand shaking using a sensing unit and then resizing a first display within a projection area. Basic principles are explained with reference to FIG. 14.

FIG. 14 is a diagram to explain a concept of a method of correcting shaking of a mobile terminal according to a second embodiment of the present invention on Z-axis.

Referring to (a) of FIG. 14, a mobile terminal 100 is projecting a first display 30 on a prescribed screen 10 within a projection area 20 using a projector module 155. In this case, if hand shaking takes place to move the mobile terminal 100 in direction +Z, as shown in (b) of FIG. 14, a distance between the projector module 155 and the screen 100 increases and a size of the projection area 20 on the screen 10 increases. To correct this, if the first display 30 is reduced as much as the projection area 20 increases, the first display 30 can remain on the screen 10 in the same size.

On the contrary, referring to (c) of FIG. 14, if the mobile terminal 100 moves in direction −Z, a distance between the projector module 155 and the screen 10 decreases and a size of the projection area 20 on the screen 10 decreases. If the first display 30 is enlarged as much as the projection area 20 decreases, a size, which is occupied by the first display 30 on the screen 10, does not change.

A process for applying the above-explained correction principle is identical to that of the first embodiment. Yet, the sensing unit 140 detects shaking on axis Z and generates displacement information on the detected shaking. The controller 180 differs in calculating a correction value for how much the first display will be reduced or enlarged according to the displacement information on the axis Z.

Meanwhile, the formerly explained look-up table can be applied to the present embodiment. In particular, a prescribed look-up table is prepared by previously calculating and determining a value for enlarging or reducing the first display for a prescribed displacement. Hand shaking correction can be then quickly performed by comparing the displacement information detected by the sensing unit 140 to the prescribed look-up table. In the present embodiment, it is preferable the look-up table is separately prepared according to a ratio of reducing the first display 30 to a size of the projection area 20.

In the following description, a correction method according to a third embodiment of the present invention is explained. In this case, a motion of the mobile terminal moved by user's hand shaking is performed as a rotation centering on at least one of axes X, Y and Z instead of a parallel movement in at least one direction of the axes X, Y and Z.

### Third Embodiment

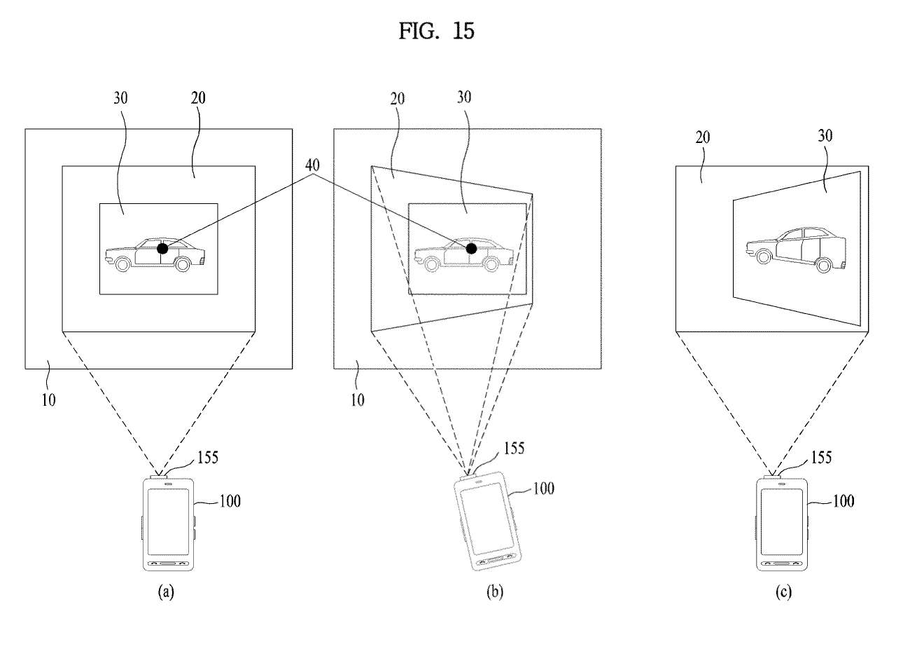

A mobile terminal according to a third embodiment of the present invention is explained with reference to FIG. 15. According to the present embodiment, a sensing unit detects a rotation, which is caused by hand shaking, on a prescribed axis of a mobile terminal. An image resulting from reducing an image to be projected by a prescribed ratio is modified and moved in parallel within a maximum projectable area based on the detected rotation. Therefore, the hand shaking can be corrected. This is explained with reference to FIG. 15.

Referring to (a) of FIG. 15, a mobile terminal 100 is projecting a first display 30 on a prescribed screen 10 within a projection area 20 using a projector module 155. In this case, as shown in (b) of FIG. 15, if hand shaking takes place to rotate the mobile terminal 100 in a left direction by taking an axis Z as a rotational axis, a left side of the screen 10 becomes farther and a right side of the screen 10 becomes closer, in viewing the screen 10 with reference to the projector module 155.

Therefore, a right side of the projection area 20 becomes wider, a right side of the projection area 20 becomes narrower, and its center deviates from the center 40 of the screen 10 to incline to the left. As a result, the projection area 20 becomes a trapezoid. In this case, referring to (c) of FIG. 15, in order to cancel out a rotation extent of the mobile terminal 100, an image is projected within the projection area 20 in a manner of modifying the first display 30 into a trapezoid shape having a narrow left side and a wider right side and then moving it in parallel to the right. If so, hand shaking is corrected. Hence, it is able to maintain the shape and position, as shown in (b) of FIG. 15, of the first display 30, which is before the occurrence of the hand shaking, on the screen 10.

A process for applying the above-explained correction principle is identical to that of the first embodiment. Yet, the sensing unit 140 detects rotation on a prescribed axis and generates displacement information on the detected rotation. The controller 180 differs in calculating a correction value for how much the first display will be modified and moved in parallel according to the displacement information.

Meanwhile, the formerly explained look-up table can be applied to the present embodiment. In particular, a prescribed look-up table is prepared by previously calculating and determining a value for modifying and moving the first display 30 in parallel for a prescribed displacement. Hand shaking correction can be then quickly performed by comparing the displacement information detected by the sensing unit 140 to the prescribed look-up table. In the present embodiment, it is preferable the look-up table is separately prepared according to a ratio of reducing the first display 30 to a size of the projection area 20.

When the hand shaking correcting method according to one of the first to third embodiments is applied, it is able to make a user difficult to recognize hand shaking correction using an area except a first display 30 within a projection area. This is explained with reference to a fourth embodiment.

### Fourth Embodiment

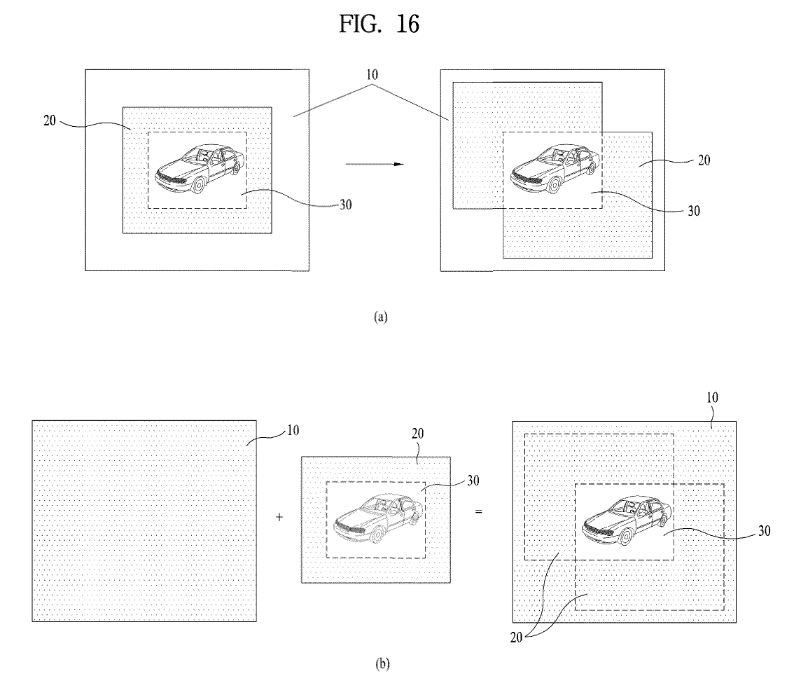

A mobile terminal according to a fourth embodiment of the present invention is explained with reference to FIG. 16. According to the present embodiment, a color of a screen can be recognized via camera, the recognized color is projected on a second display that is an area of a projection area except a first display. Therefore, a user has difficulty in recognizing hand shaking correction. This method is explained with reference to FIG. 16.

Referring to (a) of FIG. 16, a mobile terminal 100 is projecting a first display 30 on a screen 10 within a projection area 20 using a projector module 155. In this case, if any image is not allocated to an area except the first display 30 within the projection area 20, nothing or a prescribed basic color can be projected according to a type of the projector module 155.

In particular, in case that a prescribed image is projected on a specific portion within a maximum projectable area, it is a matter how the projector module will process the rest portion except the specific portion. If the projector module projects light on a specific portion and cuts off light from the rest portion completely, there is no problem.

Yet, in case of a projector module configured to always project a prescribed basic color within a maximum projectable area, although the hand shaking is performed by the above-explained method, the basic color is projected on a second display to move along a motion of a mobile terminal due to hand shaking. Therefore, a user recognizes the hand shaking through the motion of the area on which the basic color is projected.

To improve this, a camera 121 is further provided to the mobile terminal 100. And, it is able to recognize a color of the screen by photographing the screen 10 through the camera 121. If the recognized color is projected on the second display, since a color of an area except the first display in the projection area is equal to that of the screen 10, a user hardly recognizes hand shaking, as shown in (b) of FIG. 16, despite that the mobile terminal moves. Therefore, the user is able to view the first display 30 more pleasantly.

According to one embodiment of the present invention, the above-described methods can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet).

Configurations and methods of the above-explained embodiments are non-limitedly applicable to the mobile terminal having the projector module. Therefore, the embodiments are combined entirely or in part selectively to provide various modifications and variations.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal to project and stabilize an image, the mobile terminal comprising:
a projection module adapted to project a first display image within a projection area corresponding to a maximum projectable size on an external plane;
a sensing unit adapted to detect movement of the mobile terminal; and
a controller adapted to control the projection module to maintain the first display image at a fixed position on the external plane by moving the first display image within the projection area to correct for the detected movement.

2. The mobile terminal of claim 1, wherein the first display image comprises a projection-specific image resulting from reduction according to the maximum projectable size and a prescribed ratio.

3. The mobile terminal of claim 1, wherein:
the sensing unit is further adapted to determine displacement information corresponding to the detected movement; and
the controller is further adapted to determine a correction value using the determined displacement information and to control the projection module to modify the first display image using the correction value.

4. The mobile terminal of claim 3, further comprising a memory adapted to store a look-up table and wherein the controller is further adapted to determine the correction value by referring to the look-up table.

5. The mobile terminal of claim 4, wherein a range of correction displacement in the look-up table is set differently according to a reduction ratio of the first display image.

6. The mobile terminal of claim 3, wherein:
the sensing unit determines the displacement information by detecting movement on X and Y axes; and
the controller controls the projection module to move the first display image on at least the X or Y axis within the projection area according to the displacement information to correct for the detected movement.

7. The mobile terminal of claim 3, wherein:
the sensing unit determines the displacement information by detecting movement on a Z axis; and
the controller controls the projection module to resize the first display image on at least an X or Y axis within the projection area according to the displacement information to correct for the detected movement.

8. The mobile terminal of claim 3, wherein:
the sensing unit determines the displacement information by detecting rotation centered about at least an X, Y or Z axis; and
the controller controls the projection module to transform the first display image on at least the X or Y axis within the projection area according to the displacement information and to move the transformed first display image to correct for the detected rotation.

9. The mobile terminal of claim 1, wherein the controller is further adapted to control the projection module to project a second display image on a portion of the projection area other than a portion on which the first display image is projected.

10. The mobile terminal of claim 9, further comprising a camera adapted to recognize a color of the external plane and wherein the controller is further adapted to control the projection module to project the recognized color as the second display image.

11. A method of stabilizing a projected image in a mobile terminal, the method comprising:
projecting a first display image within a projection area corresponding to a maximum projectable size on an external plane;
detecting movement of the mobile terminal; and
maintaining the first display image at a fixed position on the external plane by moving the first display image within the projection area to correct for the detected movement.

12. The method of claim 11, wherein the first display image comprises a projection-specific image resulting from reduction according to the maximum projectable size and a prescribed ratio.

13. The method of claim 11, further comprising:
determining displacement information corresponding to the detected movement;
determining a correction value using the determined displacement information; and
modifying the first display image using the correction value.

14. The method of claim 13, wherein determining the correction value comprises referring to a look-up table.

15. The method of claim 14, further comprising setting a range of correction displacement in the look-up table differently according to a reduction ratio of the first display image.

16. The method of claim 13, wherein determining the displacement information comprises detecting movement on X and Y axes and further comprising moving the first display image on at least the X or Y axis within the projection area according to the displacement information to correct for the detected movement.

17. The method of claim 13, wherein determining the displacement information comprises detecting movement on a Z axis and further comprising resizing the first display image on at least an X or Y axis within the projection area according to the displacement information to correct for the detected movement.

18. The method of claim 13, wherein determining the displacement information comprises detecting rotation centered about at least an X, Y or Z axis and further comprising:
transforming the first display image on at least the X or Y axis within the projection area according to the displacement; and
moving the transformed first display image to correct for the detected rotation.

19. The method of claim 11, further comprising projecting a second display image on a portion of the projection area other than a portion on which the first display image is projected.

20. The method of claim 19, further comprising:
recognizing a color of the external plane; and
projecting the recognized color as the second display image.
